(19) United States
(12) Patent Application Publication
(10) Pub. No.: US 2008/0002381 A1
(43) Pub. Date: Jan. 3, 2008

(54) Intraball connection module

(76) Inventor: Roberto Estefano, Cotia (BR)

Correspondence Address: MYERS & KAPLAN;INTELLECTUAL PROPERTY LAW, L.L.C., CUMBERLAND CENTER II, 3100 CUMBERLAND BLVD , SUITE 1400, ATLANTA, GA, 30339, US

(21) Appl. No.: 11/638,207

(22) Filed: Dec. 13, 2006

(30) Foreign Application Priority Data
Jun. 28, 2006 (BR) PI0602923-0

(51) Int. Cl. H01R 9/00

(52) U.S. Cl. 361/773

(57) ABSTRACT

The present invention refers to an “INTRABALL CONNECTION MODULE”, that is interconnected to an electronic board (2) by the communication means (3), thus allowing data transmission, information exchange and recharging the battery (6) installed in the electronic board (2).

The connection module (1) comprises a connector (4), where a pin is introduced that allows internal access to the electronic board (2).

Patent of invention descriptive report for “INTRABALL CONNECTION MODULE”

The present patent refers to an intraball connection module intended to connect an electrical and/or electronic device introduced in sport balls by means of a special connector and pin.

### PRIOR ART

Perfect results in sport games are being increasingly sought, since a number of interests and a significant number of investors are involved.

Currently, an increasing number of mistakes is seen during sport games determinations, such as, for example, a soccer goal scored or a volleyball point.

Such mistakes occur due to human error and by the referees supervising the match. These mistakes can be easily checked by watching the match replay.

In view of the above, technology is being increasingly used in sport fields/courts worldwide in order to avoid the repetition of mistakes.

Several elements used for detecting a ball are known in the prior art. However, they show several drawbacks, such as the impossibility of carrying the charge of the battery that feeds the ball internal sensor.

Additionally, said battery is continuously turned on, thus quickly consuming the complete charge.

### OBJECTS OF THE PRESENT INVENTION

The objects of the present invention are reached by an intraball connection module that is interconnected to an electronic board by communication means, thus allowing data transmission, information exchange and recharging a battery installed in the electronic board that feeds it, one of the ends of the connection module being connected to the board by the communication means.

The connection module comprises a connector, where a pin is introduced that allows internal access to the electronic board aiming to collect data, recharge the battery, exchange information or inhibit the board operation;

### SUMMARIZED DESCRIPTION OF THE DRAWINGS

FIG. 1 is a schematic view of the module, object of the present invention;

FIG. 2 is a sectional view of the module connector, object of the present invention;

FIG. 3 is a schematic view of the on/off pin of the module, object of the present invention; and

FIG. 4 is a second schematic view of the module, object of the present invention.

### DETAILED DESCRIPTION OF THE DRAWINGS

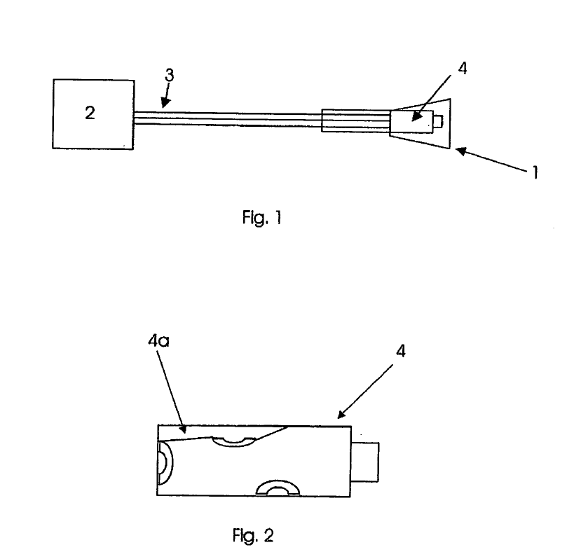

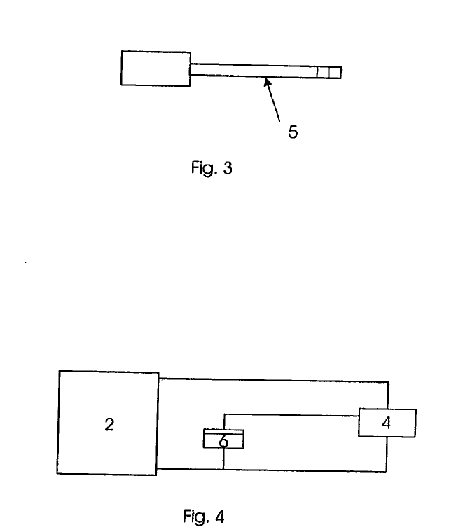

As it can be seen in FIG. 1, the connection module 1, the function of which is to allow the access to an electronic board 2, interconnected by communication means 3 and allowing data transmission, information exchange and recharging the battery 6 installed in the electronic board 2 that feeds it, one of the ends of the connection module 1 being connected to the board 2 by the communication means 3.

The communication means 3 may be cords or any other means that is functional according to the teachings of the present invention.

The connection module 1 comprises a connector 4, preferably in three positions. As a main feature, it comprises an internal key 4a interconnecting one or other position as an appropriate pin is positioned. FIG. 2 shows this feature.

Connector 4 is preferably encapsulated in rubber and will be attached to the ball in a position that is diametrically opposed to that where the ball inflation needle is attached.

Externally, a pin is introduced in connector 4 that allows internal access to the electronic board 2 aiming to collect data, recharge the battery 6, exchange information or inhibit the operation of board 2.

The electronic board 2 collects data referring to the use of the sport ball and may forward data by wireless means and is provided in the center of the ball, arranged in a rigid strip (not showed) that crosses the internal diameter of a sport ball.

This rigid strip is provided with any functional material, such as, TPU, PU, PVC, rubber, SBR, nitrile and other colorless or colored compounds; also, the electronic board 2 attachment is of any kind, provided that it complies with the teachings of the present invention.

Said electronic board 2 is able to cooperate with receiver devices, preferably antennas provided with armoring to avoid interferences and arranged in the peripheral lines of a field/court or even inside a soccer/handball goal post.

The antennas send the signal to a central and the central alerts the match referee when the ball crosses these lines. The referee will be provided with a signaling device.

Thus, when the ball crosses the peripheral lines of a field/court, the referee will be absolutely sure that the ball crossed the line and validates the goal, scores the point or even determines that the ball is out of the field/court.

Further, the data collected by the electronic board 2 may be collected by the connection module 1.

The connector 4 further allows battery recharge and the on/off function. When a pin 5 is placed in the connector, the internal key 4a is turned off and the battery of board 2 is disconnected. Then, the board 2 is isolated and the charger will work on the battery only, thus allowing its recharge.

The battery charger is adapted from a commercially available standard charger having the appropriate output voltage. Its outlet is connected to an electronic module that works as a voltage regulator and a battery full charge indicator.

The charger output voltage is determined by the voltage of the battery 6 employed. So as to indicate full charge of battery 6, a comparator is used and light indication is provided so that the user is advised whether the battery is recharged or not.

The on/off pin 5 may be used for carrying or storing the balls without requiring the electronic board 2 to be operating, that is, carrying out the effective function of turning the battery off and, thus, not allowing the electronic board to work. FIG. 4 shows the operation of the connection module 1.

Obviously, it will be appreciated that while the abovementioned is described as an illustrative example of the present invention, all other changes and variations thereof, as it would be evident to those skilled in the art, are considered within the wide scope of the present invention as per the attached claims.

1. “INTRABALL CONNECTION MODULE”, characterized in that it is interconnected to an electronic board (2) by communication means (3), thus allowing data transmission, information exchange and recharging the battery (6) installed in the electronic board (2) that feeds it, one of the ends of the connection module (1) being connected to the board (2) by the communication means (3); and
the connection module (1) comprises a connector (4), where a pin is introduced that allows internal access to the electronic board (2) aiming to collect data, recharge the battery (6), exchange information or inhibit the operation of board (2).

2. “INTRABALL CONNECTION MODULE”, as claimed in claim 1, characterized in that the electronic board (2) collects data referring to the use of the sport ball and forwards data by wireless means and is provided in the center of the ball, arranged in a rigid strip that crosses the internal diameter of a sport ball.

3. “INTRABALL CONNECTION MODULE”, as claimed in claim 1, characterized in that the data collected by the electronic board (2) are collected by the connection module (1).

4. “INTRABALL CONNECTION MODULE”, as claimed in claim 3, characterized in that, when a pin (5) is placed in the connector (4), the internal key (4a) is turned off and the battery of board (2) is disconnected.

5. “INTRABALL CONNECTION MODULE”, as claimed in claim 3, characterized in that the connector (4) allows recharge of battery (6).

6. “INTRABALL CONNECTION MODULE”, as claimed in claim 1, characterized in that the communication means (3) are cords.
